(19) United States
(12) Patent Application Publication
(10) Pub. No.: US 2026/0283414 A1
(43) Pub. Date: Sep. 24, 2026

(54) FABRIC MAGNETIC COUPLER DEVICE

(71) Applicant: Mark G. TEGEN, Austin (TX)

(72) Inventor: Mark G. TEGEN, Austin, TX (US)

(21) Appl. No.: 19/474,279

(22) PCT Filed: Apr. 12, 2024
(86) PCT No.: PCT/US2024/024351

§ 371 Date: Oct. 10, 2025

Related U.S. Application Data
(60) Provisional application No. 63/458,769, filed on Apr. 12, 2023.
(60) Provisional application No. 63/522,225, filed on Jun. 21, 2023.

(51) Int. Cl. A47K 10/14; F16M 13/02

(52) U.S. Cl. CPC A47K 10/14; F16M 13/022

(57) ABSTRACT

In alternative embodiments, provided are products of manufacture designed as fabric holding apparatus, for example, towel holding apparatus, for providing a ready access to a fabric (a towel) by a user. In alternative embodiments, provided are apparatus for removably holding fabrics, for example, a towel, to stationary surfaces such as fencing and fence poles, and thereby providing an easy access to the fabric by a user. The apparatus comprises one or two or more magnets wrapped or enclosed in opposite ends of a rectangular fabric that create a magnetically coupled, reversible bond or grip to the towel when placed on opposite sides of the towel and allowed to magnetically couple. When the fabric with the magnetic device is introduced or placed against a metallic surface, such as a tennis court fencing or fence pole, comprising steel or galvanized steel a magnetically reversible bond is established between the metallic surface.

### RELATED APPLICATIONS

This Patent Convention Treaty (PCT) International Application claims the benefit of priority under 35 U.S.C. § 119(e) of U.S. Provisional Patent Application Ser. No. (USSN) 63/458,769, filed Apr. 12, 2023; and U.S. Ser. No. 63/522,225, filed Jun. 21, 2023. The aforementioned applications are expressly incorporated herein by reference in their entirety and for all purposes. All publications, patents, patent applications cited herein are hereby expressly incorporated by reference for all purposes.

### TECHNICAL FIELD

This invention generally relates to consumer and sports products. In alternative embodiments, provided are products of manufacture designed as fabric holding apparatus, for example, towel holding apparatus, for providing a ready access to a fabric (for example, a towel) by a user. In alternative embodiments, provided are apparatus for removably holding fabrics, for example, a towel, to stationary surfaces such as fencing and fence poles, and thereby providing an easy access to the fabric by a user.

### BACKGROUND

Towels are widely used in a variety of sports and recreational activities by users such as sportsmen, fishermen, hunters, golfers and tennis players for a variety of purposes. Such purposes may include, but are not limited to, wiping sweat of faces and/or hands of the users; and drying and/or cleaning of playing equipment, and such similar equipment or accessories that may be employed by the users. Accordingly, there is an increase in demand of having the towels readily accessible whenever needed by the users and preferably not thrown on the ground or court between uses. More particularly, the users such as the sportsmen require towels to be readily accessible at all times while playing sports. For example, in the game of tennis, it is important that playing equipment, such as racket grips, remains dry and free from dirt for increasing the accuracy of shots taken by tennis players while playing tennis. Further, it is essential that the playing equipment is regularly dried to remove moisture and sweat during highly humid conditions. Furthermore, it is important that tennis player's hands remain dry to enhance grip on the racket while playing and allows the player to also remove sweat from the body during play. To serve the aforementioned requirements, the tennis players usually throw or drop the towel on the court surface in proximity to the court playing surface, but out of play so as to not create an obstruction during play, and then access the towel again when required by picking it up off the ground, removing sweat from their person or persons and equipment and then returning the towel to the ground before play commences again. The towel is allowed to contact the ground, usually wet with sweat and thereby picks up dirt and debris that could be a hygiene concern or debris from the ground could affect the tennis equipment whereby dirt could be transferred to the grip which could impact player performance. Further, the action of bending down to pick up the towel from the ground potentially hundreds of times during a series of tennis games and tennis sets would be exhausting for the player and not a productive use of energy during play. It should be understood that such problems may be faced by any of the aforementioned users who require towels while performing a particular activity. Accordingly, users, including tennis players, require a detachable holding apparatus for holding the towels, such that part of the holding apparatus is attached to stationary items of the court area comprising fencing, fence vertical support poles and fence covering netting or fabric whereby the towel can be detachably secured off the ground by magnetic force, thereby making the towels readily accessible while performing the activity. Suitable examples of such items comprise fencing, fence supports, netting that covers fence supports and fencing.

Various holding apparatuses have previously been disclosed that may be employed by the users for holding towels to an item, such as a belt and/or any other article of clothing, of the users. A conventional holding apparatus includes a clasp that extends through an eyelet of a towel. Further, the clasp releasably connects with an item of a user. However, the conventional holding apparatus requires the towel to include the eyelet as a means for attaching the towel to the clasp that attaches to the item of the user. Accordingly, such a conventional holding apparatus may be capable of holding only those towels that include eyelets or such similar means of attachment. Another conventional holding apparatus includes an upper portion that includes a means for fastening to a user's front waist area. Further, the conventional holding apparatus includes a lower portion, which has a layer of a towel of a specific shape and dimension. However, the conventional holding apparatus is capable of holding a towel of a specific shape and dimension thereby reducing flexibility of the user to choose any kind of a towel. Accordingly, such a conventional holding apparatus has a limited utility and may not be used to hold different kinds of readily available towels. Still another conventional holding apparatus is capable of providing an easy access of the towel by a user but includes a mechanism that permanently secures the towel to the conventional holding apparatus, thereby preventing removal of the towel from the conventional holding apparatus when required for washing purposes after use. In U.S. Pat. No. 7,698,789B2 Cserpes discloses a detachable magnetic holding apparatus that may be employed by a user for removably holding a towel as fixed to the user. Consequently, there is a need to develop a holding apparatus that may be employed by a user for removably securing a towel to fencing, fence support or fabric covering fencing but is not attached to the user.

### SUMMARY

In alternative embodiments, provided are products of manufacture designed as a fabric (for example, a towel) holding apparatus, for example, tennis towel holding apparatus, for providing a ready access to a fabric (for example, a towel) by a user. In alternative embodiments, products of manufacture as provided herein are used as holding apparatus that may be employed by a user for removably securing a fabric (for example, a towel) to fencing, fence support or fabric covering fencing but is not attached to the user. In alternative embodiments, products of manufacture as provided herein are capable of attaching to an item, such as fencing, fence support or fence covering fabric that is not attached to the user to provide an easy accessibility of the towel by the user. In alternative embodiments, products of manufacture as provided herein can be easily removed from the anchor point and provide for a shaped or flexible contact point to allow for easy and secure storage between uses and easy movement of the device when players switch ends of the court between games and sets, thereby providing a convenient way to remove the fabric (for example, a towel) from the holding apparatus. In alternative embodiments, products of manufacture as provided herein act as holding apparatus that are light-weight, and easy-to-use. In alternative embodiments, products of manufacture as provided herein act as holding apparatus that are able to hold fabrics (for example, a towel) of any shape and size.

In alternative embodiments, provided are products of manufacture, or a fabric holding apparatus, for providing a ready access to a user, comprising:
an attachment assembly comprising:
one magnet, or a plurality of, or two, three or four or more, magnets, wherein the magnet or magnets are connected to (or fixed in, glued to, or sewn into) a locking clamp, or a fabric coupling instrument,
wherein the one magnet, or the plurality of, or two, three or four or more, magnets within the connecting device or the fabric coupling instrument are capable of reversibly or detachably affixing a second fabric within a coupling instrument surface,
and wherein the product of manufacture or the fabric holding apparatus is capable of being removed or detached from a metal surface by the user.

In alternative embodiments, the user is a tennis, baseball, basketball, badminton, football or pickelball player or players. In alternative embodiments, the user is a construction worker or agricultural worker, or an industrial or factor worker.

In alternative embodiments, the metal surface comprises or is fabricated as a fence or fence support, or a metal wall, metal machinery or a bulkhead.

In alternative embodiments, the fabric is or comprises a towel or a rag, or a hat or a shirt.

In alternative embodiments, the magnet is a permanent magnet, and optionally the permanent magnet comprises a ceramic magnet, a ferrite magnet, an alnico (or aluminum, nickel and cobalt) magnet, a samarium cobalt (SmCo) magnet, or a neodymium, iron, and boron (NIB) magnet. In alternative embodiments, the plurality of magnets are affixed or attached to the fabric using an epoxy glue, a cyanoacrylate glue, a polyurethane glue, or a structural acrylic adhesive. In alternative embodiments, the plurality of magnets are affixed or attached to the fabric by being sewn (stitched) into the fabric.

In alternative embodiments a single magnet or multiple magnets are attached to a component of the device comprising a clamp or a clasp and the fabric is secured in the clamp or clasp which is attached to the magnet.

The details of one or more exemplary embodiments of the invention are set forth in the accompanying drawings and the description below. Other features, objects, and advantages of the invention will be apparent from the description and drawings, and from the claims.

All publications, patents, patent applications cited herein are hereby expressly incorporated by reference in their entireties for all purposes.

### DESCRIPTION OF DRAWINGS

The drawings set forth herein are illustrative of exemplary embodiments provided herein and are not meant to limit the scope of the invention as encompassed by the claims.

The advantages and features of the present invention will become better understood with reference to the following detailed description and claims taken in conjunction with the accompanying drawings, in which:

FIG. 1 depicts a perspective view of a court fencing 100 (for example, tennis court fencing), and fence vertical support poles 200.

FIG. 2 depicts a perspective view of an exemplary towel holding apparatus 400 that is removably holding a towel 300 and is magnetically coupled to a fence vertical support pole 200.

FIG. 3 depicts a perspective view of an exemplary magnetic towel holding device 400, the magnets 500 arrangement to allow the towel to be secured in the device 400 and the towel 300.

FIG. 4 depicts a top-down perspective view of the exemplary magnetic towel holding device 400, the multiple magnets 500 arrangement to allow the towel to be secured in the device 400 and the towel 300, and the reversible magnetic coupling to the fence vertical support pole 200.

FIG. 5 depicts a top-down perspective view of the exemplary magnetic towel holding device 400, the optional reduced number of magnets arrangement to allow the towel to be secured in the device 400 and the towel 300, and the reversible magnetic coupling to the fence vertical support pole 200.

FIG. 6 depicts a top-down perspective view of the exemplary magnetic towel holding device 400, the optional addition of a single magnet 500 to couple to the vertical support pole and multiple magnets 500 arrangement to allow the towel to be secured in the device 400 and the towel 300, and the reversible magnetic coupling to the fence vertical support pole 200.

FIG. 7 depicts a side perspective view of the exemplary magnetic towel holding device 400, a locking clip mechanism 600 is connected to the magnet 500 by a rubber lanyard 700.

FIG. 8 depicts a top-down perspective view of the exemplary magnetic towel holding device 400, the locking clip mechanism 600 is connected to the magnet 500 by a rubber lanyard 700.

FIG. 9 depicts a top-down perspective view of the exemplary magnetic towel holding device 400, the locking clip mechanism 600 is connected to the magnet 500 by a rubber lanyard 700; and, the locking clip mechanism 600 is attached to a towel 300.

Like reference symbols in the various drawings indicate like elements.

### DETAILED DESCRIPTION

In alternative embodiments, provided are products of manufacture designed as fabric (for example, a towel) holding apparatus, for example, tennis towel holding apparatus, for providing a ready access to a fabric (for example, a towel) by a user. In alternative embodiments, the apparatus comprises a magnet enclosed in a cover, optionally a rubberized cover with an attachment point, whereby a flexible lanyard or a wire is attached, and the other end of the lanyard is attached to a clamp (optionally a locking clamp) where the towel is secured inside the clamp. When the magnet end of the device is introduced or placed against a metallic surface, for example, a fencing, or a tennis court fencing or fence pole, for example comprising steel or galvanized steel, a magnetically reversible bond is established between the metallic surface (optionally a fence or a fence pole) and the magnetic end of the device, whereby the opposite end of the device is holding the fabric (for example, a towel), for example, a tennis towel. The fabric (for example, a towel, for example, a tennis towel), can be used and returned to a magnetically secure position off the ground and can be removed or moved from the connection point for use and reintroduced to the connection point for storage during or between use by a user, for example, a worker, a player or players.

In alternative embodiments, the apparatus comprises a magnet enclosed in a cover, optionally a rubberized cover with an attachment point, whereby a metal ring, optionally comprising a key ring, is attached to a clamp (optionally a locking clamp) where the towel is secured inside the clamp. When the magnet end of the device is introduced or placed against a metallic surface, for example, a fencing, or a tennis court fencing or fence pole, for example comprising steel or galvanized steel, a magnetically reversible bond is established between the magnetic surface (optionally a fence or fence pole) and the magnetic end of the device, whereby the opposite end of the device is holding the fabric (for example, a towel), for example, a tennis towel. The fabric (for example, a towel), for example, a tennis towel, can be used and returned to a magnetically secure position off the ground and can be removed or moved from the connection point for use and reintroduced to the connection point for storage during or between use by a user, for example, a worker, a player or players.

In alternative embodiments, the apparatus comprises a magnet enclosed in a cover, optionally a rubberized cover with an attachment point, whereby a clamp (optionally a locking clamp) is connected to the magnet and where the fabric, optionally towel, is secured inside the clamp. When the magnet end of the device is introduced or placed against a metallic surface, for example, a fencing, or a tennis court fencing or fence pole, for example comprising steel or galvanized steel, a magnetically reversible bond is established between the magnetic surface (optionally a fence or fence pole) and the magnetic end of the device whereby the opposite end of the device is holding the fabric (for example, a towel), for example, a tennis towel. The fabric (for example, a towel), for example, a tennis towel, can be used and returned to a magnetically secure position off the ground and can be removed or moved from the connection point for use and reintroduced to the connection point for storage during or between use by a user, for example, a worker, a player or players.

In alternative embodiments, the apparatus comprises at least two magnets wrapped or enclosed in opposite ends of a rectangular fabric that create a magnetically coupled, reversible bond or grip to the towel when placed on opposite sides of the fabric (for example, a towel) and allowed to magnetically couple. When the fabric (for example, a towel) with the magnetic device is introduced or placed against a metallic surface, for example, a fencing, or a tennis court fencing or fence pole, for example comprising steel or galvanized steel, a magnetically reversible bond is established between the fence or fence pole and the magnetically coupled device holding the fabric (for example, a towel), for example, a tennis towel. The fabric (for example, a towel), for example, a tennis towel, can be used and returned to a magnetically secure position off the ground and can be removed or moved from the connection point for use and reintroduced to the connection point or new connection point for storage during or between use by a user, for example, a worker, a player or players.

In alternative embodiments, provided are products of manufacture designed to provide a holding apparatus that may be employed for removably holding fabric (for example, a towel), and in alternative embodiments can include any or all the advantages of previous holding apparatus and/or can overcome drawbacks inherent in previous holding apparatus.

In alternative embodiments, provided are products of manufacture designed as a holding apparatus capable of removably holding a towel and attaching to an item, such as fencing, fence supports or fencing covered in wind fabric or fence supports covered in wind fabric or wind break material (for example, plastic windbreak netting or metal windbreak panel, for example, a material made of high density polyethylene (HDPE)) to provide an easy accessibility of the fabric (for example, a towel) by the user.

In alternative embodiments, provided are products of manufacture designed to provide a holding apparatus that may be easily disassembled for conveniently removing a fabric (for example, a towel) from the holding apparatus when required by a user for cleaning or replacing the fabric (for example, a towel) with a fresh fabric (for example, a towel).

In alternative embodiments, provided are products of manufacture designed to provide a light-weight and an easy-to-use holding apparatus for removably holding a fabric (for example, a towel) and securing it to a position.

In alternative embodiments, provided are products of manufacture designed to provide a holding apparatus that is capable of removably holding fabric (for example, a towel) of any shape and size.

In alternative embodiments, provided are fabric (for example, a towel) holding apparatus for providing a ready access to a fabric (for example, a towel) by a user. In alternative embodiments, an exemplary fabric (for example, a towel) holding apparatus comprises an attachment assembly. The attachment assembly comprises a coupling mechanism capable of being detachably attached to a stationary item such as fence supports, fencing, fence support pole covered in fabric or fencing covered in fabric. Further, the attachment assembly comprises a ferromagnetic surface whereby the towel attachment device first couples the towel magnetically and then itself is reversibly attached to a ferromagnetic surface comprising fencing, fence support, fencing covered in fabric or a fence support covered in fabric. In alternative embodiments the attachment assembly comprises at least two (2) magnets (can have additional magnets, for example, 3, 4, 5, 6, or more magnets) thereby first attaching to the towel and then together with the towel is reversibly attached to a magnet or ferromagnetic surface. In alternative embodiments the attachment assembly includes 4 or more magnets thereby first attaching to the fabric (for example, a towel) and then together with the towel is reversibly attached to a magnet or ferromagnetic surface. In alternative embodiments the attachment device includes 3 or more magnets thereby first attaching to the fabric (for example, a towel) and then together with the towel is reversibly attached to a magnet or ferromagnetic surface where the first 2 magnets secure the towel and the 3^{rd} magnet secures the device to a magnet or ferromagnetic surface.

In alternative embodiments the fabric (for example, a towel) attachment device 400 comprises two or more magnets 500 that are enclosed in a fabric where at one end the device is open and at the opposite end the device is closed. When the device is 400 is fully opened it is one piece of fabric in a square, round or rectangle shape with a rectangle shape being preferred. As a towel 300 is coupled to the device 400 the two ends of the device are place on opposite side of the towel and each magnet 500 is placed adjacent to the corresponding magnet thereby creating a reversible magnetic lock on the towel. The magnets 500 are placed in proximity to each other that are removably fixed to the towel by magnetic force by placement on opposite sides of the towel whereby the two or more magnets are allowed to create a magnetic bond between the two or more magnets creating a secure magnetic attachment point on the towel. The towel attachment device, once secured to the towel, is then placed in direct contact the ferromagnetic surface 100 and 200. In alternative embodiments, the towel attachment device can consist of one magnet and one ferromagnetic item of similar size and shape or one magnet or ferromagnetic item physically attached to the towel by means of items comprising clips, clamps, pins or hooks. In alternative embodiments the device can have 3 or more magnets with 2 magnets securing the towel and a 3^{rd} magnet securing the device to the ferromagnetic surface. In a preferred embodiment, the device consists of 4 magnets.

For a better understanding of the present invention, its operating advantages, and the specific objects attained by its uses, reference should be made to the accompanying drawings and the descriptive matter in which there are illustrated exemplary embodiments as provided herein.

The exemplary embodiments described herein detail for illustrative purposes are subject to many variations in structure and design. It should be emphasized, however, that the present invention is not limited to a particular towel holding apparatus, or the exemplary towel holding apparatus as shown and described.

It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting. The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The use of “including,” “comprising,” or “having” and variations thereof herein is meant to encompass the items listed thereafter and equivalents thereof as well as additional items. Unless limited otherwise, the terms “attached,” “coupled,” and “engaged,” and variations thereof herein are used broadly and encompass direct and indirect attachments, couplings, and engagements. In addition, the terms “attached” and “coupled” and variations thereof are not restricted to physical or mechanical attachments or couplings.

In alternative embodiments, provided is a fabric (for example, a towel) holding apparatus that may be employed by a user for removably holding a fabric (for example, a towel) to a stationary ferromagnetic surface. In alternative embodiments, provided is a fabric (for example, a towel) holding apparatus that is capable of being detachably attached to a fixed structure such as a fence, fence support or fence covering fabric, thereby providing an easy accessibility of the fabric (for example, a towel) by the user.

In alternative embodiments, the term, ‘user,’ as used herein, refers to a person that may use the towel holding apparatus of the present invention. Such a person or persons may be a tennis player or tennis players, baseball or basketball players, pickleball players, or any other individual who may be in a need for a ready access to a towel for a specific purpose, or example, an individual on a boat, or construction workers or agricultural field workers. Suitable examples of such a purpose may include, but are not limited to, wiping sweat or moisture from face and/or hands of the user; and drying and/or cleaning of playing equipment, and such similar equipment or accessories that may be employed by the user.

As used herein, the term ‘item’ may refer to fence, fence support or fence covering fabric, however, it should be understood that the term may also refer to other such fixed or semi fixed structures accessible to the user during play or periods between games or sets.

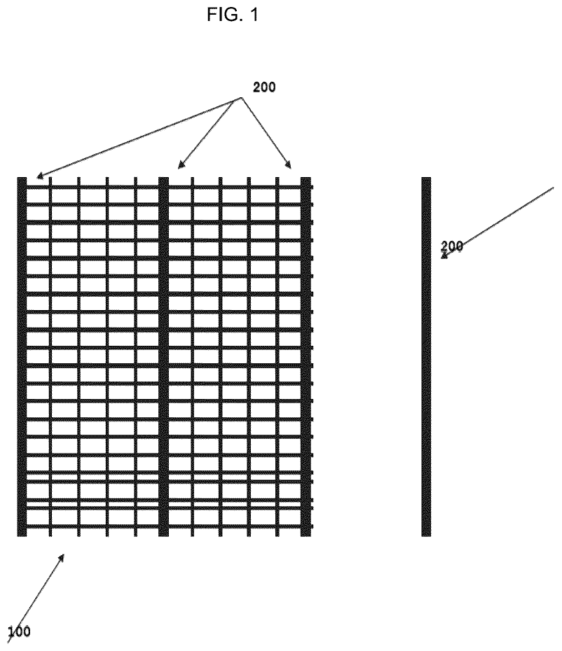

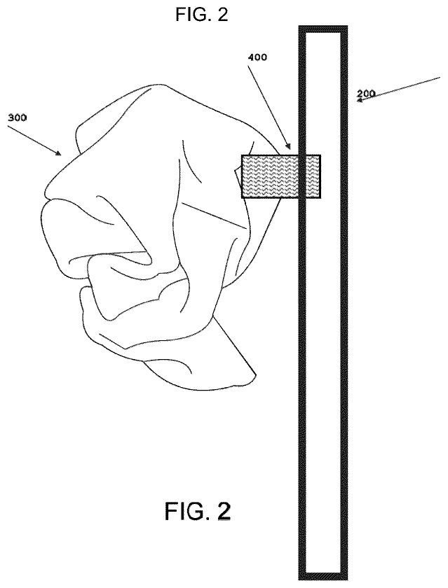

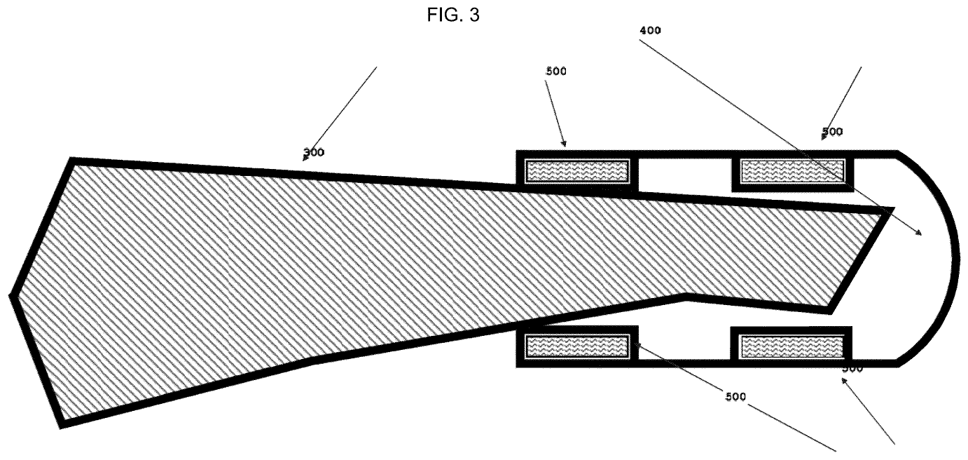

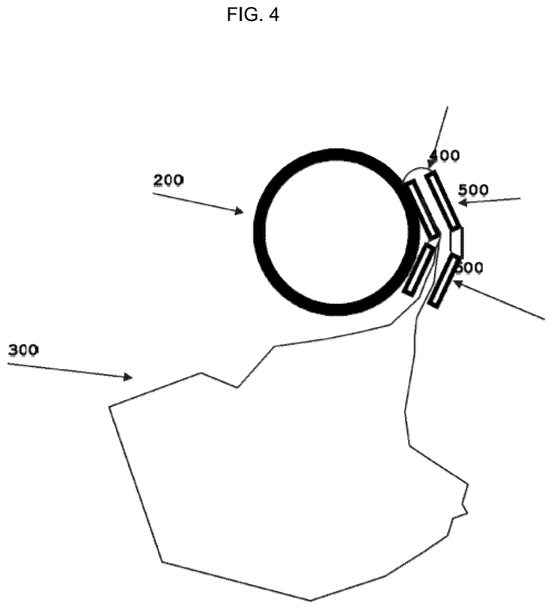

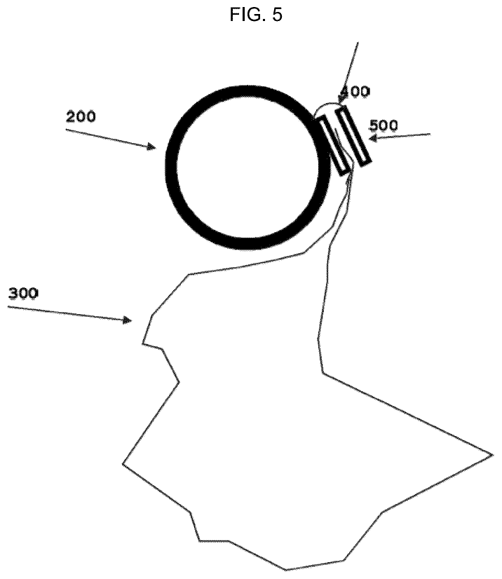

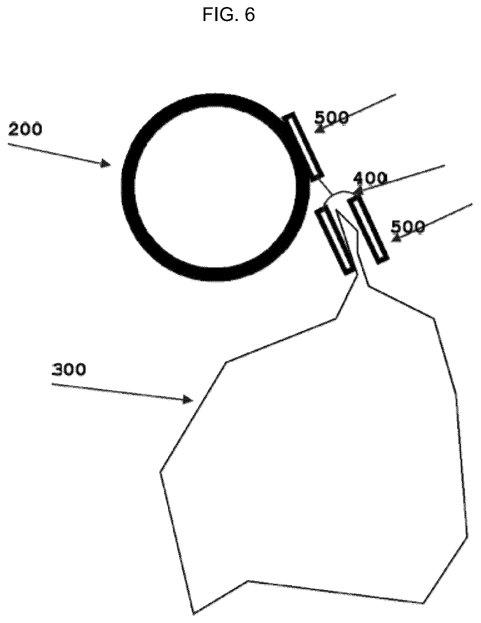

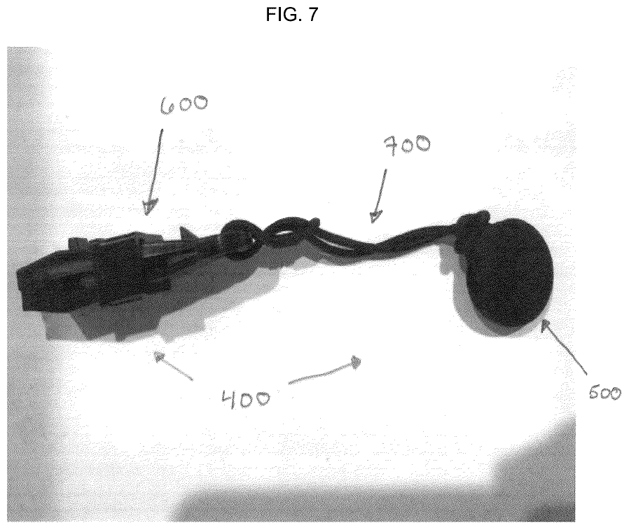

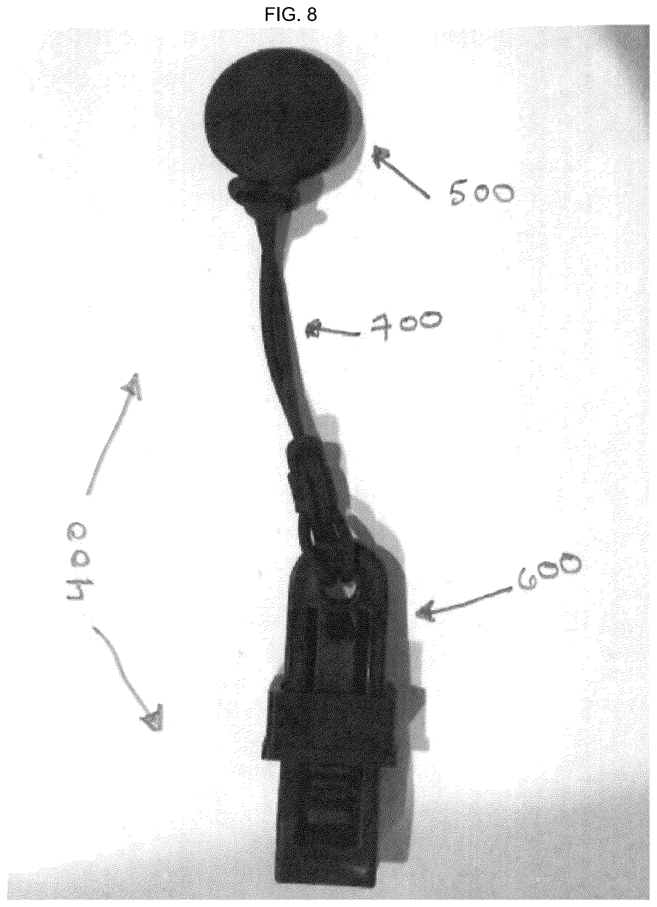

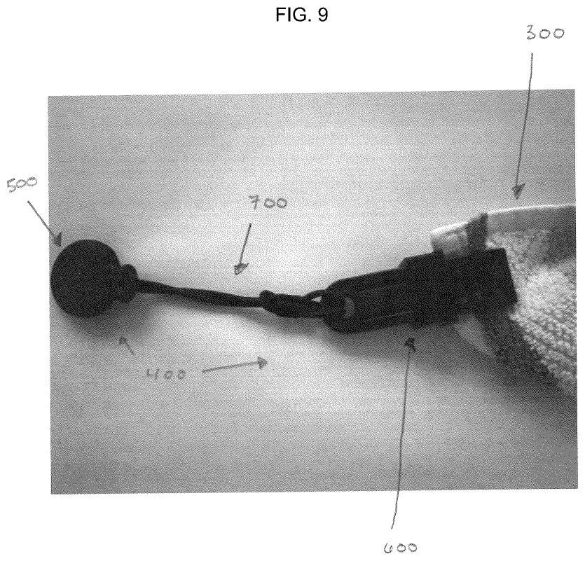

Exemplary fabric (for example, a towel) holding apparatus for removably holding a towel is explained in detail in conjunction with FIG. 1, FIG. 2, FIG. 3, FIG. 4, FIG. 5, FIG. 6, FIG. 7, FIG. 8 and/or FIG. 9.

FIG. 1 depicts a perspective view of a fence 100, and fence pole or vertical support pole 200. Further, FIG. 2 depicts a perspective view of an exemplary fabric (for example, a towel) holding apparatus 400 that is removably holding a towel 300, and is reversibly magnetically anchored to a vertical support pole 200. FIG. 3 depicts a perspective view of an exemplary fabric (for example, a towel) holding apparatus 400 that is removably holding a towel 300, and shows the magnets 500 arrangement opposite sides of the towel 300 to create the magnetic lock on the towel 300. FIG. 4 depicts a top down view of an exemplary fabric (for example, a towel) holding apparatus 400 that is holding a towel 300, and is reversibly magnetically anchored with 4 magnets 500 creating multiple or two contact points to a vertical support pole 200. FIG. 5 depicts a top down view of an exemplary fabric (for example, a towel) holding apparatus 400 that is holding a towel 300, and is reversibly magnetically anchored with 2 magnets 500 creating a single contact points to a vertical support pole 200. FIG. 6 depicts a top down view of an exemplary fabric (for example, a towel) holding apparatus 400 that is holding a towel 300 with 2 magnets 500, and is reversibly magnetically anchored with 1 magnet 500 creating a single contact points to a vertical support pole 200 that is independent from the towel securing magnets.

As depicted in FIG. 3, the exemplary towel holding apparatus 400 includes 2 or more (for example, 3, 4, 5, 6 or more) magnets 500 that are arranged opposite each other so when they are forced together with the towel between them they create a magnetic seal holding the towel 300. In alternative embodiments, one magnet is used with, on the opposite side of the device, a ferromagnetic item comprising iron, coated iron or nickel so as to create the magnetic seal holding the towel in place within the holding apparatus.

In alternative embodiments, exemplary holding apparatus 400, comprise a fabric or metal device with a hinge point to allow for the towel to be inserted into the device. In alternative embodiments, the fabric or metal allows the magnet or magnets to be secured or fixed in the proper position on opposite sides of each other. Further, it should be understood that the holding apparatus 400 may be made of a material, which is robust, corrosion-resistant, and light-weight. Suitable examples of such a material may comprise alloys such as stainless-steel, plastic, nylon, wool, cotton, and the like. In alternative embodiments, an exemplary fabric (for example, a towel) holding apparatus 400 may be designed in any suitable shape and size that enables a convenient and a detachable attachment of the holding apparatus 400 and the towel 300. In addition to the above, the holding apparatus 400 may be provided in a variety of colors according to a manufacturer's and/or a user's preference.

In alternative embodiments the term, ‘towel 300,’ as used herein refers to a towel or either an accessory of the user or an article of clothing of the user. Referring to FIG. 1 a fence 100 is shown with the vertical support poles 200 also shown. The vertical support poles can also be horizontal support poles and would serve as an anchor point for the holding apparatus. The number of fence sections or support poles present on the court can be greater than 1 and FIG. 1. is shown as an example only of a single fence section. In alternative embodiments, many tennis courts have fabric or wind netting that covers the inside or outside of the tennis court fencing. The holding apparatus can be secured to the fencing or the support pole with the wind netting present.

Referring to FIG. 2 a towel 300, a holding device 400 and a vertical support pole 200. The holding device 400 is first secured to the towel 300 and then the holding device which is still magnetic is then presented to the fence or fence support pole 200 where it creates a reversible magnetic attachment to the fence or fence pole thereby allowing the tennis player to remove the towel with holding device attached to it from the support pole, use the towel to clean his or her face or body and his or her equipment and then return the towel 300 to the anchor point or transfer the towel to a new anchor point such as a new vertical support pole 200.

Referring to FIG. 3, a towel 300, 4 magnets 500 and an exemplary fabric assembly or holding device 400 is shown. The holding apparatus is comprising a fabric or metal device in the shape of a “U” that is open at one end and closed at the opposite end. The towel 300 can be clasped into the device which is a single unit of 1 or more magnets and if 1 magnet is used then the opposite side of the device has a ferromagnetic item that allows the towel to be secured by magnetic force, however the FIG. 3 depicts 4 magnets. As shown in FIG. 4 the purpose of 4 magnets 500 is to allow for multiple points of contact to a fence support pole providing better grip for the player when securing the holding apparatus to the fence or fence pole anchor point. As fence vertical support poles are often round having 2 magnetic points of contact provides for a more secure contact to the anchor point.

Referring to FIG. 9, a towel 300, 1 magnet 500 and an exemplary locking clamp 600 of the device 400 is shown. The magnet 500 is attached to the locking clamp 600 by the use of a rubber lanyard 700. The towel 300 is shown in the diagram and is secured to the device 400 by the locking clamp 600.

In alternative embodiments, any magnets can be used, or a magnet and a ferromagnetic item, to create the magnetic reversible lock on the towel. Suitable magnets comprise magnetite or lodestone, cobalt and nickel, gadolinium, dysprosium, samarium-cobalt and neodymium-iron-boron, Ceramic, or ferrite, magnets are made of a sintered composite of powdered iron oxide and barium/strontium carbonate ceramic. The magnets can be solid or flexible.

In alternative embodiments, the term, ‘removably coupled’ signifies a magnetic coupling of the first set of magnets 500 opposite each other as shown in the device 400. Such a magnetic coupling enables the towel 300 to be locked into the device reversibly when pulled apart from each other. Once the towel 300 is secured and the magnets are coupled they still maintain a magnetic field and can be then collectively with the towel, be placed against an anchor point such as a vertical support pole and be coupled to the vertical support pole removably or reversibly coupled to the support pole.

In alternative embodiments, the size of the device can vary depending on preference of the tennis player or the number of magnets used. Alternative embodiments comprise the use of 4 or 6 neodymium permanent magnets measuring 1.26 inches by 1.26 by 0.08 inches thick. In alternative embodiments the holding device is 10 inches total length with the magnets enclosed in a nylon fabric starting at the ends of the fabric and spaced every 2 inches and an example would be magnets at 0 inches, 2 inches and 4 inches from each end with the middle of the fabric for the holding device free of magnets. In alternative embodiments, the second set of magnets, like the first set of magnets, includes two or more magnets, circular, rectangle or square, that are coupled to each other to form a magnetic pole having a specific magnetic polarity opposite to the magnetic polarity of the first set of magnets. Such an opposite magnetic polarity of the second set of magnets enables the removable coupling with the first set of magnets.

In alternative embodiments the holding assembly includes a holding member capable of removably holding the towel. Accordingly, the towel holding apparatus provides an easy accessibility of the towel by the user. In alternative embodiments, shapes and sizes, and functionality of various components of the towel holding apparatus allow it to be a light-weight and an easy-to-use towel holding apparatus. In alternative embodiments, due to an employment of a two-part magnetic closure, the towel holding apparatus may be easily disassembled into the attachment assembly and the holding assembly for conveniently removing the towel therefrom. In such a manner, the towel holding apparatus serves as an effective tool and provides a mechanism that allows the towel to be readily accessible by the user. In alternative embodiments, the towel holding apparatus is capable of removably holding towels of any shape and size.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and thereby enable others skilled in the art to best utilize the present invention and various embodiments with various modifications as are suited to the particular use contemplated. It is understood that various omissions and substitutions of equivalents are contemplated as circumstances may suggest or render expedient, but such are intended to cover the application or implementation without departing from the spirit or scope of the claims of the present invention.

### Products of Manufacture and Kits

Provided are products of manufacture and kits for practicing methods as provided herein; and optionally, products of manufacture and kits can further comprise instructions for practicing methods as provided herein.

Any of the above aspects and embodiments can be combined with any other aspect or embodiment as disclosed here in the Summary, Figures and/or Detailed Description sections.

As used in this specification and the claims, the singular forms “a,” “an” and “the” include plural referents unless the context clearly dictates otherwise.

Unless specifically stated or obvious from context, as used herein, the term “or” is understood to be inclusive and covers both “or” and “and”.

Unless specifically stated or obvious from context, as used herein, the term “about” is understood as within a range of normal tolerance in the art, for example within 2 standard deviations of the mean. About (use of the term “about”) can be understood as within 20%, 19%, 18%, 17%, 16%, 15%, 14%, 13%, 12% 11%, 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless specifically stated or obvious from context, as used herein, the terms “substantially all”, “substantially most of”, “substantially all of” or “majority of” encompass at least about 75%, 80%, 85%, 90%, 91%, 92%, 93%, 94%, 95%, 96%, 97%, 98%, 99% or 99.5%, or more of a referenced amount of a composition.

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents. Incorporation by reference of these documents, standing alone, should not be construed as an assertion or admission that any portion of the contents of any document is considered to be essential material for satisfying any national or regional statutory disclosure requirement for patent applications. Notwithstanding, the right is reserved for relying upon any of such documents, where appropriate, for providing material deemed essential to the claimed subject matter by an examining authority or court.

Modifications may be made to the foregoing without departing from the basic aspects of the invention. Although the invention has been described in substantial detail with reference to one or more specific embodiments, those of ordinary skill in the art will recognize that changes may be made to the embodiments specifically disclosed in this application, and yet these modifications and improvements are within the scope and spirit of the invention. The invention illustratively described herein suitably may be practiced in the absence of any element(s) not specifically disclosed herein. Thus, for example, in each instance herein any of the terms “comprising”, “consisting essentially of”, and “consisting of” may be replaced with either of the other two terms. Thus, the terms and expressions which have been employed are used as terms of description and not of limitation, equivalents of the features shown and described, or portions thereof, are not excluded, and it is recognized that various modifications are possible within the scope of the invention. Embodiments of the invention are set forth in the following claims.

A number of embodiments of the invention have been described. Nevertheless, it can be understood that various modifications may be made without departing from the spirit and scope of the invention. Accordingly, other embodiments are within the scope of the following claims.

What is claimed is:

1. A product of manufacture, or a fabric holding apparatus for providing a ready access to a user, comprising:
an attachment assembly comprising:
one magnet, or a plurality of, or two, three or four or more, magnets, wherein the magnet or magnets are connected to (or fixed in, glued to, or sewn into) a locking clamp, or a fabric coupling instrument,
wherein the one magnet, or the plurality of, or two, three or four or more, magnets within the connecting device or the fabric coupling instrument are capable of reversibly or detachably affixing a second fabric within a coupling instrument surface,
and wherein the product of manufacture or the fabric holding apparatus is capable of being removed or detached from a metal surface by the user.

2. The product of manufacture, or the fabric holding apparatus of claim 1, wherein the user is a tennis, baseball, basketball, badminton, football or pickelball player or players.

3. The product of manufacture, or the fabric holding apparatus of claim 1, wherein the user is a construction worker or agricultural worker, or an industrial or factor worker.

4. The product of manufacture, or the fabric holding apparatus of claim 1, where the metal surface comprises or is fabricated as a fence or fence support, or a metal wall, metal machinery or a bulkhead.

5. The product of manufacture, or the fabric holding apparatus of claim 1, wherein the fabric is or comprises a towel or a rag, or a hat or a shirt.

6. The product of manufacture, or the fabric holding apparatus of claim 1, wherein the magnet is a permanent magnet.

7. The product of manufacture, or the fabric holding apparatus of claim 1, wherein the permanent magnet comprises a ceramic magnet, a ferrite magnet, an alnico (or aluminum, nickel and cobalt) magnet, a samarium cobalt (SmCo) magnet, or a neodymium, iron, and boron (NIB) magnet.

8. The product of manufacture, or the fabric holding apparatus of claim 1, wherein the plurality of magnets are affixed or attached to the fabric using an epoxy glue, a cyanoacrylate glue, a polyurethane glue, or a structural acrylic adhesive.
